(19) United States
(12) Patent Application Publication
(10) Pub. No.: US 2009/0165451 A1
(43) Pub. Date: Jul. 2, 2009

(54) HYDRAULIC FLUID ACCUMULATOR WITH INTEGRATED HIGH-PRESSURE AND LOW-PRESSURE CHAMBER

(75) Inventors: Matthias Mueller, Neusaess (DE); Markus Kliffken, Elchingen (DE)

Correspondence Address: SCULLY SCOTT MURPHY & PRESSER, PC, 400 GARDEN CITY PLAZA, SUITE 300, GARDEN CITY, NY, 11530, US

(73) Assignee: BOSCH REXROTH AG, Stuttgart (DE)

(21) Appl. No.: 12/279,413

(22) PCT Filed: Apr. 23, 2007
(86) PCT No.: PCT/EP07/03549

§ 371 Date: Aug. 14, 2008

(30) Foreign Application Priority Data
Apr. 27, 2006 (DE) 10 2006 019 672.4

(51) Int. Cl. F16L 55/04

(52) U.S. Cl. 60/478; 138/30

(57) ABSTRACT

The invention relates to a hydraulic fluid accumulator (30) having a high-pressure chamber (32) and a low-pressure chamber (33), wherein the high-pressure chamber (32) provided with an equalizing volume (36) is disposed in the low-pressure chamber (33). Provided at the hydraulic fluid accumulator (30) is an external connection (34) for the equalizing volume (36), by means of which connection the equalizing volume (36) can be filled with a gas having a predefinable pressure.

The invention relates to a hydraulic fluid accumulator with a low-pressure chamber and with a high-pressure chamber which is disposed in the low-pressure chamber.

Known from the German published patent application DT 25 51 580 A1 is a hydraulic energy accumulator system for machines, in particular for motor vehicles having a high-pressure and a low-pressure accumulator, there being connected in circuit between these accumulators a positive-displacement machine that can be operated as a motor and as a pump. The high-pressure accumulator and low-pressure accumulator of the hydraulic energy accumulator system constitute a structural unit, the high-pressure accumulator, which is realized as a bubble accumulator, being disposed inside the low-pressure accumulator.

It is disadvantageous in this case that the high-pressure accumulator integrated inside the low-pressure accumulator is a bubble accumulator whose equalizing volume cannot be adjusted externally, such that, in the case of application of the integrated high-pressure accumulator in a hydraulic energy accumulator system, it is not possible to alter the maximum pressure that can be attained in the hydraulic fluid of the high-pressure accumulator. In particular, it is disadvantageous that the equalizing volume cannot be reduced in the case of very high temperatures of the hydraulic fluid, with the result that the maximum internal pressure for which the high-pressure accumulator is designed can be exceeded under these conditions.

The object of the invention is to create a high-pressure accumulator which is integrated into the low-pressure accumulator and which has a variable gas pressure in the equalizing volume.

The object is achieved by the hydraulic fluid accumulator, according to the invention, having the features of Claim 1.

The hydraulic fluid accumulator according to the invention has a high-pressure chamber which is provided with an equalizing volume and which is structurally integrated into a low-pressure container or low-pressure chamber. Provided in the high-pressure chamber of the hydraulic fluid accumulator according to the invention is a first connection for the equalizing volume, whereby it is possible to fill into the equalizing volume a quantity of gas whose pressure can be predefined.

According to the invention, in the hydraulic fluid accumulator a pressure in the equalizing volume is adjustable such that the maximum possible pressure load of the high-pressure chamber disposed in the low-pressure chamber can be adapted variably to external conditions such as, for example, a high temperature of the hydraulic fluid. In the case of a higher temperature, the quantity of gas enclosed in the equalizing volume assumes a greater volume, with the result that, overall, less hydraulic fluid can be stored in the high-pressure chamber. If, on the other hand, the equalizing volume is accessible from the outside, the enclosed quantity of gas can be reduced, whereby, in turn, space is created to accommodate further hydraulic fluid.

Furthermore, it is advantageous that the high-pressure chamber of the hydraulic fluid accumulator according to the invention is disposed in the low-pressure chamber, thereby preventing the situation in which, in the case of bursting of the high-pressure chamber as a result of excessively high internal pressure, persons in the surrounding area are injured by the parts that have burst out from the chamber.

Advantageous developments of the hydraulic fluid accumulator according to the invention are specified in the sub-claims.

It is advantageous that the high-pressure chamber of the hydraulic fluid accumulator according to the invention can be connected to a hydraulic energy accumulator system via a second connection. It is thus possible for kinetic energy of the connected hydrostatic drive to be stored in the hydraulic energy accumulator system as high pressure in a hydraulic fluid which is filled into the high-pressure chamber. Advantageously, this stored energy can be made available to the hydrostatic drive in an acceleration operation.

In particular, it is advantageous that the first connection is a gas valve, since it is thereby possible for the equalizing volume and the pressure in the equalizing volume to be adjusted in a simple and properly proportionable manner.

Moreover, it is advantageous that the high-pressure chamber of the hydraulic fluid accumulator according to the invention is connected to an externally installed gas supply via a metering device. The first connection installed directly at the high-pressure chamber is thereby reliably protected against being destroyed as a result of an unintended occurrence of excess pressure.

Furthermore, it is advantageous that the metering device is a regulable pressure-limiting valve, whereby automatic or program-controlled adjustment of the pressure in the equalizing volume of the high-pressure chamber is possible.

A further advantage of the hydraulic fluid accumulator according to the invention consists in that the gas supply to the high-pressure chamber is realized via a compressed-air connection. This is advantageous, in particular, if the system as a whole already has a compressed-air reservoir that can be tapped for supplying the equalizing volume.

The supplying of gas to the equalizing volume by means of a gas cylinder filled with chemically inert gas such as, for example, nitrogen, is advantageous, since a cylinder can be manipulated in a flexible mariner and is easily fitted, and the use of a chemically inert gas ensures that the hydraulic fluid does not react with the gas of the equalizing volume.

Advantageously, there is installed in the low-pressure chamber and/or high-pressure chamber a sensor which measures the fill level and/or the temperature of the hydraulic fluid therein, the sensor being so connected to the throttle via a programmable microprocessor that the pressure in the equalizing volume of the high-pressure chamber can be regulated in dependence on the fill level of the hydraulic fluid in the low-pressure chamber.

Advantageously, the high-pressure chamber is realized as a bubble accumulator, piston accumulator or spring accumulator, or as a combination of these accumulator types.

A preferred exemplary embodiment of the invention is represented in the drawing and explained more fully in the following description. In the drawing:

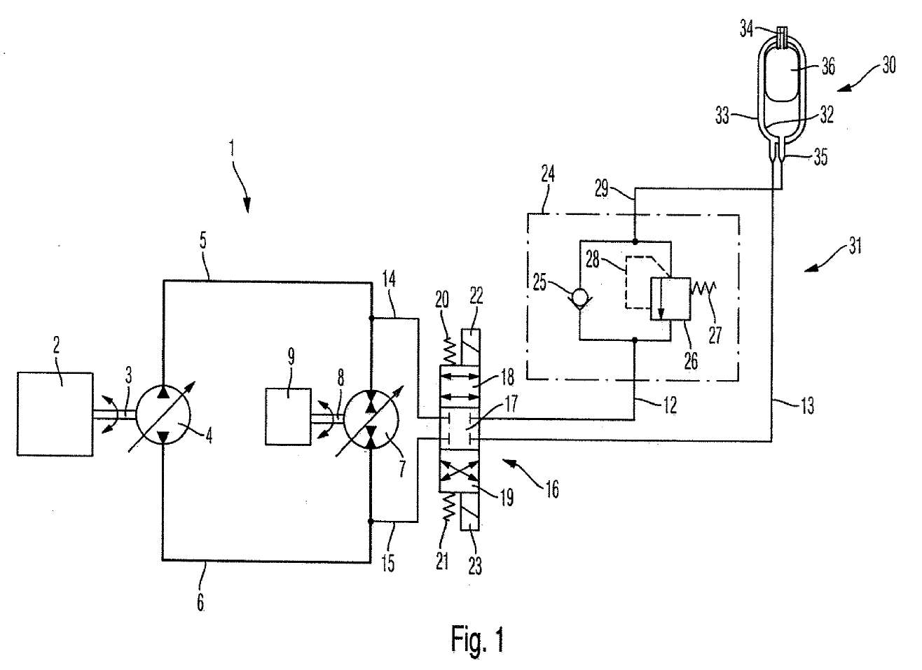

FIG. 1 shows a schematic representation of a hydrostatic drive having a hydraulic energy accumulator system, to which there is connected a hydraulic fluid accumulator according to the invention, and

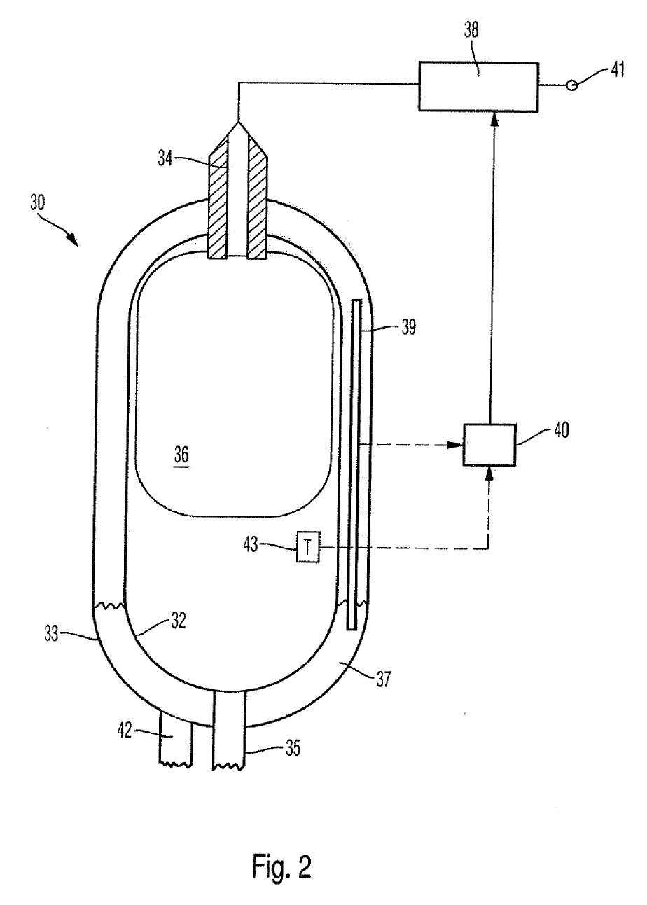

FIG. 2 shows an exemplary embodiment of a hydraulic fluid accumulator according to the invention.

To aid understanding of the hydraulic fluid accumulator 30 according to the invention, an exemplary hydraulic energy accumulator system 31, operating in combination with a hydrostatic drive or a hydrostatic transmission 1, is first explained with reference to FIG. 1, following which the details of the hydraulic fluid accumulator 30 according to the invention are explained with reference to FIG. 2.

A hydrostatic transmission 1 of a travel drive is represented in FIG. 1. The travel drive comprises a driving machine 2, which is preferably realized as a diesel internal combustion engine. The driving machine 2 is coupled to a hydraulic pump 4 via a drive shaft 3. The hydraulic pump 4 is a variable piston machine provided for feeding in both directions. An axial piston machine, realized in a swashplate or bent-axis design, is used in preference. The hydraulic pump 4 is connected to a hydraulic motor 7 via a first working line 5 and a second working line 6. Flow can pass in both directions through the hydraulic motor 7, which is steplessly adjustable in respect of its displacement volume. The hydraulic pump 4 and the hydraulic motor 7, together with the first working line 5 and the second working line 6, constitute a closed hydraulic circuit. The transformation ratio of the hydrostatic transmission 1 is variable in this case through adjustment of the hydraulic pump 4 and of the hydraulic motor 7.

The hydraulic motor 7 is connected to a vehicle drive 9 via a drive shaft 8. The vehicle drive 9 may be realized in this case, for example, solely by a differential transmission or with a post-connected powershift transmission. It is equally possible for the hydraulic motor 7 to be directly connected, via the drive shaft 8, to a wheel that is to be driven. In this case, preferably, a plurality of hydraulic motors 7 are provided, one driven wheel of the vehicle being assigned to each of the hydraulic motors 7. The arrangement described in the following for recovery of the braking energy can be provided in common for a plurality of hydraulic motors, or for each hydraulic motor 7 separately.

For the purpose of storing the braking energy, hydraulic fluid of the hydraulic circuit is pumped to and fro between two accumulator elements. The accumulators in this case constitute a hydraulic balance. The hydraulic fluid accumulator 30, which comprises a high-pressure chamber 32 and a low-pressure chamber 33, is provided for this purpose. The high-pressure chamber 32, which has a second connection 35, contains an equalizing volume 36 which, according to the invention, has a first connection 34, and said high-pressure chamber is built into or integrated in the low-pressure chamber 33. A hydraulic energy accumulator system 31 which, in turn, is connected to the hydrostatic drive 1, is connected via the second connection 35 of the high-pressure chamber 32 and via the third connection 42 of the low-pressure chamber 33 of the hydraulic fluid accumulator 30 according to the invention. In this case, a connecting line 29 is connected to the second connection 35, and a connecting line 13 is connected to the third connection 42 of the hydraulic fluid accumulator 30 according to the invention. The hydraulic energy accumulator system 31 stores kinetic energy of the hydrostatic drive 1 as high pressure in the hydraulic fluid 37 present in the high-pressure chamber 32 of the hydraulic fluid accumulator 30 according to the invention.

In order for the high-pressure chamber 32 of the hydraulic fluid accumulator 30 according to the invention to be filled with hydraulic fluid 37 during the braking operation, the high-pressure chamber 32 is connected, via a high-pressure accumulator line 12, to a working line 5 or 6 which carries the high pressure during a deceleration. In deceleration, this is the working line 5, 6 located downstream from the hydraulic motor 7. During deceleration, the low-pressure chamber 33 of the hydraulic fluid accumulator 30 according to the invention is connected, via a low-pressure accumulator line 13, to the first or second working line 5, 6 carrying the lower pressure. In the exemplary embodiment, the connection of the high-pressure accumulator line 12 to the first or the second working line 5, 6 is effected via a travel-direction valve 16 which, in dependence on its operating position, connects the high-pressure accumulator line 12 to the first working line 5 via a first connecting line 14 or to the second working line 6 via a second connecting line 15. The connection of the low-pressure accumulator line 13 to the first working line 5 or to the second working line 6 is effected in the same way, via the first connecting line 14 or the second connecting line 15, in dependence on the operating position of the travel-direction valve 16.

Upon acceleration, with a full accumulator, the travel-direction valve 16 assumes a first operating position 18 or a second operating position 19, in dependence on the direction of travel and, therefore, on the direction of flow through the hydraulic motor 7. In the first operating position 18, the high-pressure accumulator line 12 is connected to the first working line 5 via the first connecting line 14. At the same time, in the first operating position 18 the low-pressure accumulator line 13 is connected to the second working line 6 via the second connecting line 15. The first operating position 18 is assumed by the travel-direction valve 16 when the first working line 5 is the working line carrying the high pressure during normal driving. In the following, this is termed forward travel. In FIG. 1, this means that the hydraulic fluid 37 is fed in the clockwise direction in the closed circuit by the hydraulic pump 4.

During acceleration in forward travel, therefore, the pressurized hydraulic fluid 37 in the high-pressure chamber 32 is supplied to the hydraulic motor 7 via the high-pressure accumulator line 12 and the first connecting line 14, as well as via a portion of the first working line 5. Owing to the pressure difference between the high-pressure chamber 32 and the low-pressure chamber 33, the hydraulic motor 7 is accelerated and the hydraulic fluid 37 fed out of the high-pressure chamber 32 through the hydraulic motor 7 is fed into the low-pressure chamber 33 via the second connecting line 15 and the low-pressure line 13. In the case of acceleration out of the high-pressure chamber 32, the hydraulic pump 4 is preferably set to zero displacement volume.

Upon occurrence of a braking operation during forward travel, the travel-direction valve 16 is brought out of its first operating position 18 and into its second operating position 19. In the second operating position 19, the high-pressure accumulator line 12 is connected to the second connecting line 15 and, via the latter, to the second working line 6. In the second operating position 19 of the travel-direction valve 16, by contrast, the low-pressure accumulator line 13 is connected to the first connecting line 14 and, via the latter, to the first working line 5. Owing to the inertia and the unchanged setting of the hydraulic motor 7, the hydraulic motor 7, which is now driven via the drive shaft 8, operates as a pump, the direction of flow through the hydraulic motor 7 remaining unchanged. This means that the hydraulic motor 7 draws in hydraulic fluid 37 out of the first connecting line 14, via the first working line 5, and feeds it into the second working line 6. The second working line 6 is connected to the high-pressure accumulator line 12 via the second connecting line 15. Since the hydraulic pump 4 is at the same time set to a zero displacement volume, feed through the hydraulic pump 4 is not possible. Consequently, the hydraulic fluid 37 fed by the hydraulic motor 7 is fed, via the high-pressure accumulator line 12, into the high-pressure chamber 32 and, through the braking operation, the kinetic energy of the vehicle is converted into potential energy.

In order that, following an acceleration operation in which the hydraulic fluid is released out of the high-pressure chamber 32 through the hydraulic motor 7 in the direction of the low-pressure chamber 33, recharging of the high-pressure chamber 32 can be achieved upon a subsequent braking operation, it is necessary merely to switch over the travel-direction valve 16 between a first and a second operating position 18, 19.

The above statements apply analogously to the opposite direction of travel, in which the hydraulic fluid 37 is fed in the counter-clockwise direction in the hydraulic circuit. The changed direction of travel is taken into account in that, during acceleration in a reverse travel direction, the travel-direction valve 16 is in its second operating position 19. If a braking operation occurs in this direction of travel, the travel-direction valve 16 is brought from the second operating position 19 into its first operating position 18. Otherwise, the above statements apply analogously.

In addition to the two operating positions 18 and 19 described, the travel-direction valve 16 has a neutral position 17. In the neutral position 17, the high-pressure accumulator line 12 and the low-pressure accumulator line 13 are disconnected from the first connecting line 14 and the second connecting line 15. Consequently, there is no connection allowing a through flow from the working lines 5, 6 to the high-pressure accumulator line 12 and the low-pressure accumulator line 13. This neutral position of the travel-direction valve 16 is preferably assumed when, following an acceleration phase, the pressure in the high-pressure chamber 32 has dropped to such an extent that meaningful use is no longer possible. During subsequent travel operation, the portion of the system provided for storing the braking energy is thus decoupled from the hydrostatic transmission 1, and the hydrostatic transmission 1 is regulated in the known manner.

The neutral position 17 of the travel-direction valve 16 is assumed by a first resetting spring 20 and a second resetting spring 21, provided that a first actuator 22 and a second actuator 23, respectively, are not activated.

The first actuator 22 and the second actuator 23 are preferably realized as electromagnets. The electromagnets can be supplied with an electric current in a particularly simple manner by a control device and thus bring the travel-direction valve 16 out of the neutral position 17, into its first operating position 18 or its second operating position 19. In this case, the first actuator 22 acts upon the travel-direction valve 16 in the same direction as the first resetting spring 20, and the second actuator 23 acts upon the travel-direction valve 16 in the opposite direction, in the same direction as the second resetting spring 21.

In the exemplary embodiment represented in FIG. 1, a pressure-maintaining means 24 is provided in the high-pressure accumulator line 12. The pressure-maintaining means 24 is connected to the high-pressure accumulator 10 via a connecting line 29.

The pressure-maintaining means 24 has a non-return valve 25, which is disposed between the high-pressure accumulator line 12 and the connecting line 29 and which opens in the direction of the high-pressure accumulator 10. A pressure-limiting valve 26 is provided in parallel to the non-return valve 25. The pressure-limiting valve 26 opens a connection allowing through flow between the connecting line 29 and the high-pressure accumulator line 12. A spring 27 acts upon the pressure-limiting valve 26 in the closing direction. In the opposite direction, the pressure prevailing in the connecting line 29 acts upon the pressure-limiting valve 26. If the hydrostatic force generated by the pressure delivered in the measuring line 28 exceeds the force of the spring 27, the pressure-limiting valve 26 is brought into an opened position, in which the connecting line 29 is brought into connection with the high-pressure accumulator line 12. In this case, the pressure in the high-pressure chamber 32 of the hydraulic fluid accumulator 30 according to the invention from which opening is effected by the pressure-limiting valve 26 can be set through the spring hardness of the spring 27. The opening of the pressure-limiting valve 26, and thereby the generation of a connection allowing through flow from the connecting line 29 to the high-pressure accumulator line 12, is in this case non-dependent on a pressure difference between the high-pressure chamber 32 and the connected working line 5 or 6. Rather, the absolute pressure in the high-pressure chamber is solely determinative. It is thereby possible to prevent the pressure of the high-pressure chamber 32 from dropping below a definable minimum pressure in the case of a virtually zero pressure in the working line 5 or 6 connected thereto.

FIG. 2 shows an exemplary embodiment of a hydraulic-fluid fluid accumulator 30, according to the invention, comprising a high-pressure chamber 32 and a low-pressure chamber 33, the high-pressure chamber 32 provided with an equalizing volume 36 being disposed in the low-pressure chamber 33.

The hydraulic fluid accumulator 30 according to the invention has a first connection 34 for the equalizing volume 36. The equalizing volume 36 can be filled with a gas via the first connection 34, the gas having a variably predefinable pressure.

The high-pressure chamber 32 can be connected to a hydraulic energy accumulator system 31 of the hydrostatic drive 1 via a second connection 35, the hydraulic energy accumulator system 31 storing kinetic energy of the hydrostatic drive 1 as high pressure of a hydraulic fluid 37 present in the high-pressure chamber 32 and making the energy stored in the hydraulic fluid 37 available to the hydrostatic drive 1 for acceleration.

The first connection 34 of the high-pressure chamber 32 of the hydraulic fluid accumulator 30 according to the invention is externally connected, via a metering device 38, e.g. a regulable pressure-limiting valve, to a gas supply realized, for example, as a compressed-air connection 41.

An embodiment variant of the hydraulic fluid accumulator 30 according to the invention consists in the gas supply being realized by means of a gas cylinder filled with a chemically inert gas, the gas cylinder being attached to the connection 41. A possible gas filling is, for example, nitrogen gas, which does not cause any chemical reaction upon contact with materials.

A further exemplary embodiment of the hydraulic fluid accumulator 30 according to the invention is based on a sensor 39 being provided in the low-pressure chamber 33 for the purpose of measuring the fill level of the hydraulic fluid 37. In this case, the sensor 39 is connected to the metering device 38 via a control device, e.g. a programmable microprocessor 40, such that the quantity of the gas to be let into and taken out from the equalizing space or equalizing volume 36 is controllable by means of the control device 40 in dependence on the quantity of the hydraulic fluid 37 in the low-pressure chamber 33. In this case, the pressure limitation of the high-pressure chamber 32 is also regulated via the control device 40, which evaluates the fill-level value determined by the sensor 39 in the low-pressure chamber 33, in that the metering device 38 is activated accordingly. That is to say, in the case of a low fill level in the low-pressure chamber 33, the pressure that is maximally possible in the high-pressure chamber 32 is increased.

The purpose of the high-pressure chamber 36 being disposed within the low-pressure chamber 33 is that, in the case of bursting of the wall of the high-pressure chamber 32, the hydraulic fluid, which is at high pressure and emerges in such a case, can be collected by the low-pressure chamber 33. In this case, whether this overflowing hydraulic fluid can be collected in the case of bursting of the wall of the high-pressure chamber 32 depends on whether there is still a sufficient residual volume in the low-pressure chamber 33.

In the case of the preferred exemplary embodiment represented in FIG. 2, this is detected by means of the optional fill-level sensor 39. The fill-level sensor 39 can be used to detect the fill level in the low-pressure chamber 33, and a particularly high pressure can be allowed in the high-pressure chamber 32 only if the residual volume available in the low-pressure chamber 33 in the case of bursting of the wall of the high-pressure chamber 32 can receive the hydraulic fluid emerging from the latter. If this is not the case, only a low pressure is allowed in the high-pressure chamber 32, this pressure being only of such magnitude, for example, that it can be withstood by the wall of the low-pressure chamber 33.

The pressure in the high-pressure chamber 32 corresponds to the gas pressure in the equalizing volume 36. The control device 40 can therefore define the pressure in the high-pressure chamber 32 via the metering device 38. If the pressure in the high-pressure chamber 32 is too high, the fill gas in the equalizing volume 36 can be discharged to reduce the pressure in the high-pressure chamber 32. Although there is then less potential energy available for driving the travel drive, there is nevertheless avoidance of the risk that, in the case of bursting of the wall of the high-pressure chamber 32, the low-pressure chamber 33 cannot collect the emerging hydraulic fluid. Normally, however, this problem does not occur, since the high-pressure chamber 32 is only filled at a particularly high pressure when the volume in the low-pressure chamber 33 is small, since the two chambers are filled alternately, as described with reference to FIG. 1.

In the case of the exemplary embodiment represented in FIG. 2, there is furthermore preferably provided in the high-pressure chamber 32 a temperature sensor 43, which measures the temperature of the pressurized hydraulic fluid in the high-pressure chamber 32. If the temperature in the high-pressure chamber 32 becomes unacceptably high, the control device 40 connected to the temperature sensor 43 can reduce the gas pressure in the equalizing volume 36, via the metering device 38, such that the pressure in the high-pressure chamber 32 is relieved, which helps to reduce the temperature of the hydraulic fluid.

The information, obtained via the temperature sensor 43, about the temperature of the pressurized hydraulic fluid can be combined with the information, obtained via the fill-level sensor 39, about the fill level of the low-pressure chamber 33. Since the low-pressure chamber 33 helps to cool the hydraulic fluid in the high-pressure chamber 32, a high temperature in the high-pressure chamber 32 can be better tolerated if there is a high fill level of the low-pressure chamber 33, such that it is necessary for the equalizing volume 36 to be relieved only if, in the case of high temperature of the hydraulic fluid in the high-pressure chamber, there is at the same time a low fill level in the low-pressure chamber 33.

Bursting of the wall of the high-pressure chamber 32 is countered in advance by the measures described above. If bursting of the wall of the high-pressure chamber does occur nevertheless, it is ensured that an adequate collection volume is available in the low-pressure chamber 33.

The high-pressure chamber 32 of the hydraulic fluid accumulator 30 according to the invention is realized either as a bubble accumulator, a piston accumulator or as a spring accumulator.

The invention is not limited to the exemplary embodiment described. Rather, any combinations or exemplary embodiments of the individual features represented in FIG. 2 are also possible, without departure from the principle according to the invention.

1. Hydraulic fluid accumulator having a high-pressure chamber and a low-pressure chamber, wherein the high-pressure chamber provided with an equalizing volume is disposed in the low-pressure chamber,
wherein
there is provided at the hydraulic fluid accumulator a first connection for the equalizing volume, by means of which connection the equalizing volume can be filled with a gas having a predefinable pressure.

2. Hydraulic fluid accumulator according to claim 1,
wherein
the high-pressure chamber is connected, via a second connection, and the low-pressure chamber is connected, via a third connection, to a hydraulic energy accumulator system of a hydrostatic drive, wherein the hydraulic energy accumulator system stores kinetic energy of the hydrostatic drive as high pressure of a hydraulic fluid present in the high-pressure chamber and makes the energy stored in the hydraulic fluid available to the hydrostatic drive for acceleration.

3. Hydraulic fluid accumulator according to claim 1,
wherein
the first connection for the equalizing volume is a gas valve.

4. Hydraulic fluid accumulator according to claim 1,
wherein
the first connection of the high-pressure chamber is externally connected to a gas supply via a metering device.

5. Hydraulic fluid accumulator according to claim 4,
wherein
the metering device is a regulable pressure-limiting valve.

6. Hydraulic fluid accumulator according to claim 4,
wherein
the gas supply is realized via a compressed-air connection.

7. Hydraulic fluid accumulator according to claim 4,
wherein
the gas supply is realized via a gas cylinder filled with a chemically inert gas.

8. Hydraulic fluid accumulator according to claim 7,
wherein
the chemically inert gas is nitrogen.

9. Hydraulic fluid accumulator according to claim 1,
wherein
a fill-level sensor, for measuring the fill level of the hydraulic fluid, is provided in the low-pressure chamber.

10. Hydraulic fluid accumulator according to claim 9,
wherein
the fill-level sensor is connected to the metering device via a control device.

11. Hydraulic fluid accumulator according to claim 10,
wherein
a pressure limitation of the high-pressure chamber is so regulated via the control device that the value of the fill level of the hydraulic fluid in the low-pressure chamber determined by the fill-level sensor is evaluated and the metering device is activated accordingly.

12. Hydraulic fluid accumulator according to claim 1,
wherein
the high-pressure chamber has a temperature sensor.

13. Hydraulic fluid accumulator according to claim 12,
wherein
a pressure limitation of the high-pressure chamber is so regulated via the control device that the value of the temperature of the hydraulic fluid in the high-pressure chamber determined by the temperature sensor is evaluated and the metering device is activated accordingly.
